(19) United States
(12) Patent Application Publication
(10) Pub. No.: US 2005/0282026 A1
(43) Pub. Date: Dec. 22, 2005

(54) Porous coating compositions for printing applications

(76) Inventors: Fuushern Wuu, Centennial, CO (US); Matthew J. Rovnak, Clearwater, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/153,226

(22) Filed: Jun. 15, 2005

Related U.S. Application Data
(60) Provisional application No. 60/580,246, filed on Jun. 16, 2004.

(51) Int. Cl. G03C 1/492; B32B 27/00

(52) U.S. Cl. 428/500

(57) ABSTRACT

Improved coating compositions for flexographic and other printing applications can comprise calcined clay, a binder and optionally one or more additional pigments. In some embodiments, the binder can comprise a natural composition and a synthetic composition. In addition, the coating composition can further comprise additives such as, for example, dispersants, defoamers, plastic pigments, rheology modifies, biocides, optical brighteners, cross-linkers, functional chemicals and combinations thereof. Due to the presence of the calcined clay, the improved coatings can have sufficient porosity to absorb water located in ink layers without employing significant amounts of expensive additives such as silicates and other porous compounds.

### CROSS-REFERENCE TO RELATED APPLICATIONS

The current application claims the benefit of priority from U.S. provisional patent application filed on Jun. 16, 2004, entitled, Porous Coating Composition For Printing Applications,” having Ser. No. 60/580,246, which is incorporated herein by reference.

### FIELD OF THE INVENTION

The invention relates to coating compositions for substrates such as, for example, linerboards that can absorb water and promote drying of ink layers during printing applications. The invention also relates to methods of coating and methods of printing.

### BACKGROUND OF THE INVENTION

Coatings can be applied to substrates such as, for example, linerboards and other paper products to improve surface properties of the substrate and to facilitate printing on desired surfaces of the substrate. In general, it can be desirable to provide substrates such as, for example, linerboards having a surface comprising a highly porous coating to facilitate absorption of the water component of the ink used in modern printing processes.

In some industries, the printing process used to apply ink to a substrate is flexographic printing. Generally, flexographic printing operations can employ a first roll that can transfer ink from a container to a second roll, which can be made up of multiple cells. The ink can then be transferred to a printing plate, where the ink can be deposited onto, for example, desired surfaces of a substrate such as, for example, a linerboard. In some printing operations, multiple colors and/or coatings of ink can be applied to a single surface of a substrate to produce a desired image. Flexographic printing is described in U.S. Pat. No. 5,439,707 to Nelli et al., entitled “Coating Formulation And Method Of Production Thereof For Post Print Waxable Linerboard,” which is hereby incorporated by reference herein.

Since modem printing applications generally include multiple coatings of ink to produce the final printed image, it is desirable to dry the ink from a previous coating before applying the subsequent ink coating. As suggested above, one way of drying ink layers during the printing process is to coat a substrate with a porous coating that can absorb water. For example, some previous coatings have employed a latex binder, titanium dioxide and amorphous silicate. These types of coating compositions are generally described in U.S. Pat. No. 5,439,707 to Nelli et al., which is hereby incorporated by reference herein. However, components such as amorphous silicates can be expensive, which can increase the costs associated with producing coating substrates suitable for use in printing applications.

### SUMMARY OF THE INVENTION

In a first aspect, the invention pertains to a linerboard comprising a board with a porous coating composition on at least one surface of the board, the porous coating composition being able to absorb water and comprising from about 55 to about 85 percent by weight calcined clay and a binder. In some embodiments, the coating composition can be substantially free of hydrous clay.

In a second aspect, the invention pertains to a method of printing comprising applying ink to at least one surface of a substrate having a porous coating composition, the porous coating composition comprising from about 55 to about 85 percent by weight calcined clay and a binder.

In a third aspect, the invention pertains to a coating dispersion comprising calcined clay, a binder, titanium dioxide and water, wherein the dispersion comprises from about thirty-five percent (30%) to about fifty percent (50%) by weight solids. In some embodiments, the coating dispersion can comprise from about forty percent (40%) to about forty-five percent (45%) solids.

In a forth aspect, the invention pertains to a method of producing a printed substrate comprising coating at least one surface of a substrate with a porous coating composition comprising calcined clay and a binder, wherein the binder comprises a natural composition and a synthetic composition. In these embodiments, the method can further comprise applying ink to the at least one coated surface of the substrate, wherein the substrate is coated with the porous coating composition and the ink is applied to the coated surface on a single line in a continuous process.

In another aspect, the invention pertains to a coating composition comprising from about 55 percent to about 85 percent calcined clay, from about 20 to about 40 percent by weight binder and from about 5 to about 15 percent by weight titanium dioxide.

In a further aspect, the invention relates to a method of forming a corrugated board comprising operably coupling a corrugated substrate or medium with a linerboard to form a corrugated board, the linerboard comprising a porous coating composition being able to absorb water and comprising from about 55 to about 85 percent by weight calcined clay and a binder.

### DETAILED DESCRIPTION OF THE INVENTION

Improved coating compositions for flexographic and other printing applications can comprise calcined clay, a binder and optionally one or more additional pigments. In some embodiments, the binder can comprise a natural composition and a synthetic composition. In addition, the coating composition can further comprise additives such as, for example, dispersants, defoamers, plastic pigments, rheology modifies, biocides, optical brighteners, cross-linkers, functional chemicals and combinations thereof. Due to the presence of the calcined clay, the improved coatings can have sufficient porosity to absorb water located in ink layers without employing significant amounts of expensive additives such as silicates and other porous compounds. By reducing and/or eliminating components such as silicates, the improved coating compositions can reduce the costs associated with producing coated substrates, which can reduce the overall costs of producing printed substrates for packaging and other applications. In some embodiments, the coating compositions can be water-based, while in other embodiments the coating compositions can be solvent-based.

In general, numerous commercial products are packaged, shipped and/or displayed to consumers in containers or displays having printing on an outside surface of the container or display. Generally, packaging and/or displays adapted for use with commercial products comprise a substrate such as a linerboard having printing on at least one surface of the substrate. In some embodiments, printing can be applied to the linerboard by a flexographic printing process, which can involve several coats of ink to produce the final image or design. For example, multi-colored graphics and designs can require fairly rapid ink drying so that additional layers of ink can be applied without distorting or smearing the image. Thus, it can be desirable to dry a first layer of ink deposited onto a substrate, before applying a subsequent layer of ink. However, flexographic printing devices do not generally include dryers to cure the ink deposited during the flexographic printing process, and as such water absorbency can be necessary to aid in the ink drying process.

As described herein, one way of drying or cuing ink layers during a printing process is to provide a substrate having a porous coating composition that can absorb water located in the ink and facilitate drying of the ink layer. More specifically, water located in the ink layer can be drawn away from the ink and into the porous coating composition, which can dry the ink layer and permit subsequent layer(s) of ink to be applied to the substrate. In some embodiments, the coating compositions can be formed by coating a substrate with an initial coating mixture comprising a binder and one or more pigments. The binder can be a natural binder, a synthetic binder or a combination thereof. In some embodiments, the initial coating mixture can comprise a solvent to facilitate applying the initial coating mixture to a substrate. In some embodiments, the solvent can be an organic solvent, while in other embodiments the solvent can be water such that the initial coating mixture is an aqueous dispersion.

The pigment employed in the coating compositions can comprise calcined clay and can be substantially free of hydrous clay. The term substantially free of hydrous clay is being used to indicate that the coating compositions can comprise less than about 10 percent, and preferably less than 5 percent, and more preferably less than 1 percent by weight hydrous clay. Additionally, in some embodiments, the coating compositions of the present disclosure can be substantially free of water.

Calcined clay, as compared to other forms of clay, is clay that has been heated until the combined water is removed and the plastic nature of the clay is destroyed. Additionally, the heating process can introduce pores into the clay such that the final calcined clay can be a collection of porous, mechanically strong particles. Unless otherwise indicated, the calcined clays used in the compositions of the present invention have not been leached to remove silica as described in U.S. Pat. No. 5,997,625, entitled “Coating Pigment For Ink-Jet Printing,” which is hereby incorporated by reference herein. Calcined clay is commercially available from, for example, Thiele Kaolin Company (Sandersville, Ga.). In contrast, the term hydrous clay is intended to describe a clay that has not been subjected to calcination.

### Initial Coating Mixtures

As discussed above, the porous coating compositions of the present invention can absorb water, which can promote drying of ink layers in flexographic and other printing methods. In some embodiments, the porous coating compositions can be formed by applying an initial coating mixture comprising a binder and one or more organic and/or inorganic pigments dispersed in a solvent to a substrate, and drying the coating mixture to remove the solvent to form the final coating composition. Additionally, the initial coating mixture can further comprise optional processing aids such as, for example, rheology modifiers, surfactants, biocides, viscosity modifiers and the like and combinations thereof.

In general, the binders of the present disclosure are materials that can aid in holding the pigment particles together and/or can aid in holding the coating composition to the substrate surface. The binders employed in the initial coating mixture can be natural binders, synthetic binders or combinations thereof. In some embodiments, a single binder may be employed, while in other embodiments a plurality of binders may be employed in a particular coating formulation. In general, any synthetic latex binder suitable for use in printing applications can be used to form compositions of the present disclosure. Suitable synthetic binders include, for example, styrene/butadiene copolymers, vinyl acrylic (VA), poly vinyl acetate (PVA), poly vinyl alcohol (PVOH), styrene acrylate, acrylics and combinations thereof. Suitable natural binders include, for example, starches, modified starches, proteins, modified proteins, and combinations thereof. Suitable starches include, for example, corn starch, potato starch, tapioca starch, waxy maize, other types of starches and combinations thereof. Suitable modified starches include, for example, ethylated starch, acid converted starch, oxidized starch, cross-linked starch, cationic starch and combinations thereof. Suitable proteins include, for example, soy protein, casein and combinations thereof. Additional binders are described in U.S. Pat. No. 5,997,625, entitled “Coating Pigment For Ink-Jet Printing,” which is hereby incorporated by reference herein.

As described above, the binder can comprise a natural composition and a synthetic composition. Any combination of natural and synthetic binder compositions suitable for use in flexographic printing applications can be employed in the coating compositions of the present disclosure. In one embodiment, the natural composition can comprise a starch, while the synthetic composition can comprise a polymer such as, for example, a styrene/butadiene copolymer. Suitable binders comprising starch and a styrene/butadiene copolymer are sold under the tradename PENSIZE® by Penford Products Co. (Cedar Rapids, Iowa).

In some embodiments, the binder can be dispersed in a suitable solvent to form a binder/solvent mixture. Suitable solvents include, for example, organic solvents, water and combinations thereof. In these embodiments, the binder/solvent mixture can comprise from about twenty percent (20%) to about fifty percent (50%) by weight solid binder, while in other embodiments the binder/solvent mixture can comprise from about twenty-five percent (25%) to about thirty-five percent (35%) by weight solid binder. In some embodiment, the binder/solvent mixture can be present in the initial coating mixture from about thirty percent (30%) to about sixty percent (60%) by weight, and in other embodiments from about forty percent (40%) to about fifty percent (50%) by weight.

The initial coating mixture of the present disclosure can include a calcined clay and/or calcium carbonate pigment. In some embodiments, the initial coating mixture can comprise calcined clay and/or leached calcined clay. As described above, calcined clay is clay that has been heated to remove the combined water located in the clay. Due to the porous nature of calcined clay, the coating compositions can have suitable water absorption properties without employing significant amounts of expensive components such as silicates and other porous compounds. Additionally, calcined clays can have increased brightness, opacity and oil absorption relative to other forms of clay. In particular, calcined clays can have suitable acceptance and absorption of inks used in flexographic printing for corrugated box manufacturing. Suitable calcined clays are commercially available from, for example, Thiele Kaolin Company (Sandersville, Ga.).

In some embodiments, the initial coating mixture can comprise calcined clay dispersed in water, which facilitates forming the initial coating mixture. In these embodiments, the calcined clay/water mixture can comprise from about forty percent (40%) to about sixty percent (60%) by weight solid calcined clay, while in other embodiments the calcined clay/water mixture can comprise form about forty-five (45%) percent to about fifty-five percent (55%) by weight solid calcined clay. In some embodiments, the initial coating mixture can comprise form about forty-five percent (45%) to about fifty-five percent (55%) by weight calcined clay/water mixture.

As described above, the initial coating mixture of the present disclosure can comprise a binder and calcined clay and/or calcium carbonate pigment dispersed in a suitable solvent. In some embodiments, the initial coating mixture can further comprise additional pigments such as, for example, plastic pigments, mineral pigments or combinations thereof. Suitable mineral pigments include, for example, calcium carbonate based pigments such as precipitated calcium carbonate (PCC), ground calcium carbonate (GCC), modified GCC, modified PCC and combinations thereof, titanium dioxide, talc, other inorganic pigments and combinations thereof. Suitable plastic pigments include, for example solid sphere pigments, hollow sphere pigments, and combinations thereof. Suitable solid sphere plastic pigments include, for example, polystyrene pigments such as DOW 722 HS, while suitable hollow sphere plastic pigments include, for example, plastic pigments comprising styrene acrylic polymer such as ROPAQUE™ (Rohm and Hass Company). In general, plastic pigments can be added to a coating composition to improve surface properties such as, for example, gloss, brightness and opacity of the coated substrate.

In some embodiments, the additional pigments can be dispersed/and or dissolved in a suitable solvent to facilitate formation of the initial coating mixture. In one embodiment, the additional pigment can comprise titanium dioxide dispersed in water. In these embodiments, the titanium dioxide/water mixture can comprise from about sixty percent (60%) to about eighty percent (80%) percent by weight solid titanium dioxide.

The compositions of the present disclosure can further comprise processing additives such as, for example, defoamers, biocides, rheology modifiers, functional chemicals, silicates, other porous compounds and combinations thereof. Suitable viscosity modifiers include, for example, polyacrylates, triols, castor oil, and sodium silicates. Suitable defoamers include, for example, tributyl phosphate, fatty polyoxyethylene esters plus fatty alcohols, and fatty acid soaps. Suitable biocides include, for example, sodium benzoate and thiocyanate. Additional additives are further described in U.S. Pat. No. 6,564,199, entitled “Kaolin Clay Pigments, Their Preparation And Use,” which is hereby incorporated by reference herein. Generally, the processing additives are present in the initial coating mixtures at a concentration of less than about five percent (5%) by weight.

In general, initial coating mixtures can be formed by mixing aqueous dispersions of one or more pigments with an aqueous dispersion of a binder to form an aqueous binder/pigment dispersion. In one embodiment, for example, an initial coating mixture can be formed by combining about fifty percent (50%) by weight of an aqueous dispersion of calcined clay having about fifty percent (50%) by weight calcined clay with about four percent (4%) by weight of an aqueous dispersion of titanium dioxide having about seventy percent (70%) by weight titanium dioxide and about forty-six percent (46%) by weight of an aqueous dispersion of a binder having about thirty percent (30%) by weight binder. Additionally, optional components such as biocides, rheology modifiers, optical brighteners and the like can be mixed into the pigment dispersions, the binder dispersion or both. Alternatively, desired amounts dry pigments and binder(s) can be added to water, or other suitable solvents, and mixed to form pigment/binder dispersions.

### Coated Substrates

As described above, the initial coating mixtures can be applied to desired substrates, such as linerboards, to facilitate the formation of substrates having a porous coating composition. In some embodiments, the initial coating mixture can comprise a binder and one or more organic and/or inorganic pigments dispersed in a suitable solvent. In these embodiments, the initial coating mixture can be applied to a desired substrate, and the solvent can be removed to form a substrate having a coating composition that can absorb water from ink layers. The resulting coating compositions, after removal of the solvent/dispersant, can be substantially free of water, or other solvents, such that the final coating composition generally comprise less than five percent (5%) by weight, and preferably less than one percent (1%) by weight water or other solvents. Additionally, in embodiments where the initial coating mixture comprises a cross-linker, or other reactive species, the final coating composition may be cross-linked.

In some embodiments, the coating composition of the present disclosure can comprise a binder and calcined clay and/or calcium carbonate. Additionally, the coating compositions can further comprise additional pigments such as, for example, titanium dioxide and additives such as defoamers, biocides, viscosity modifiers, rheology modifiers, functional chemicals and the like.

In some embodiments, the coating compositions can comprise from about ten percent (10%) by weight to about fifty percent (50%) by weight binder, while in other embodiments the composition can comprise form about twenty percent (20%) by weight to about forty percent (40%) by weight binder. One of ordinary skill in the art will recognize that additional ranges of binder within these explicit ranges are contemplated and are within the scope of the present disclosure.

The coating compositions can comprise from about fifty percent (50%) to about ninety percent (90%) by weight calcined clay and/or calcium carbonate. In other embodiments, the coating compositions can comprise from about fifty-five percent (55%) to about eighty-five percent (85%) by weight calcined clay and/or calcium carbonate, and in further embodiments from about sixty percent (60%) to about seventy percent (70%) by weight calcined clay and/or calcium carbonate. One of ordinary skill in the art will recognize that additional ranges of calcined clay and/or calcium carbonate within these explicit ranges are contemplated and are within the scope of the present disclosure. In further embodiments, the coating compositions may comprise from about fifty-five percent (55%) to about eighty-five percent (85%) calcined clay and/or leached calcined clay.

In some embodiments, the additional pigments can be present in a combination from about one percent (1%) by weight to about twenty percent (20%) by weight, while in other embodiments the additional pigments can be present in a concentration from about five percent (5%) by weight to about fifteen percent (15%) by weight. One of ordinary skill in the art will recognize that additional ranges of pigments within these explicit ranges are contemplated and are within the scope of the present disclosure.

The compositions of the present disclosure can further comprise processing additives such as, for example, defoamers, biocides, rheology modifiers, functional chemicals and combinations thereof. Generally, the processing additives are present at a concentration of less than about five percent (5%) by weight.

### Processing to Form Coating Compositions and Coated Substrates

The processing of the initial coating mixture and the formation of coated substrates comprises combining the components of the initial coating mixture and coating desired surface(s) of a substrate with the coating mixture. Additionally, the processing may comprise applying one or more ink layers to the coated substrate by, for example, flexographic printing or the like. In general, to form the initial coating mixture of the present disclosure, desired amounts of binder, calcined clay, optional processing additives, optional additional pigments and a solvent can be combined and mixed in a mechanical mixer or a blender to form a pigment/binder dispersion. In some embodiments, a high shear disperser may be employed for blending dry products.

The initial coating mixture, or pigment/binder dispersion, can be applied to desired surfaces of a substrate to facilitate printing on the substrate. In some embodiments, the initial coating mixture can be applied to a single surface of the substrate, while in other embodiments the initial coating mixture can be applied to multiple surfaces of the substrate. The initial coating mixtures can be applied to desired substrates by any suitable process such as, for example, spraying, dip coating, roll coating and combinations thereof. Suitable process equipment for applying the compositions to a substrate include, for example, rod coater, blade coater, film coater, fountain coater, air knife coater, gate roll coater, sprayers, flexographic printer and combinations thereof. In some embodiments, the initial coating mixture can be applied to a desired substrate using an applicator roll, which can rotate through a bath containing the initial coating mixture and apply the coating mixture to desired surfaces of a substrate. Additionally, a rotating rod, running against the coating laden substrate, can then remove portion of the initial coating mixture from the substrate in a metered fashion. The metering can be controlled by, for example, altering the rotating speed of the rod, the direction of the rotation and the pressure of the rod against the substrate.

Once the initial coating mixture has been applied to the desired surface of a substrate, the water or other solvents can be removed to form the final coating composition. In some embodiments a dryer can be used to remove the water or other process solvents. In some embodiments, the coated substrates can be heated from about 2 to about 10 seconds at a temperature of about 250° F. to about 350° F.

In some embodiments, the coating weight after the solvent has been removed, can be from about 0.5 pounds per one thousand square feet (lb/msf) to about 75 lb/msf, while in other embodiments the coating weight can be from about 10 lb/msf to about 50 lb/msf and in further embodiments from about 3 lb/msf to about 5 lb/msf. One of ordinary skill in the art will recognize that additional ranges of coating weight within these explicit ranges are contemplated and are within the scope of the present disclosure.

In general, the porous coating compositions can be applied to any substrate designed to be used in a printing application where water absorbency is desired to dry ink layers deposited onto the substrate. Suitable substrates include for example, copy paper, ink jet printing paper, linerboards and the like. In general, linerboard is paper produced specifically to be combined with a corrugated medium to form a corrugated board. Suitable linerboards include, for example, bleached linerboards, white-top linerboards, unbleached linerboards, and combinations thereof. The linerboards can be composed of virgin fibers, recycled fibers or a combination thereof. In some embodiments, the basis weight of the uncoated linerboards can be from about 5 lb/msf to about 250 lb/msf, while in other embodiments the basis weight of the uncoated linerboards can be from about 20 lb/msf to about 100 lb/msf. One of ordinary skill in the art will recognize that additional ranges of basis weight for the uncoated linerboards within these explicit ranges are contemplated and are within the scope of the present disclosure.

In some embodiments, the coated linerboards can be fed into a flexogrpahic printing process where a first layer of ink can be deposited onto desired surfaces of the substrate. Once the first layer of ink has been absorbed by the coating composition, a subsequent layer of ink can be deposited on the substrate. Additionally, the coated linerboards can be combined with a corrugated substrate or medium to form a corrugated board having a surface comprising a porous coating composition. In some embodiments, the coated linerboards can be produced in a roll form and unwound as the roll is fed into a device suitable for combining the linerboard with a corrugated medium.

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention.

1. A linerboard comprising:
a board with a porous coating composition on at least one surface of the board, the porous coating composition being able to absorb water and comprising from about 55 to about 85 percent by weight calcined clay and a binder.

2. The linerboard of claim 1 wherein the coating composition further comprises a pigment selected from the group consisting of precipitated calcium carbonate (PCC), ground calcium carbonate (GCC), modified PCC, modified GCC, titanium dioxide, talc, plastic pigments and combinations thereof.

3. The linerboard of claim 2 wherein the additional pigment is present in the coating composition at a concentration from about 1 to about 20 percent by weight.

4. The linerboard of claim 1 wherein the binder is selected from the group consisting of styrene/butadiene copolymers, vinyl acrylic (VA), poly vinyl acetate (PVA), poly vinyl alcohol (PVOH), latex binders, styrene acrylate, acrylics, starches, modified starches, proteins, modified proteins and combinations thereof.

5. The linerboard of claim 1 wherein the binder comprises a natural composition and a synthetic polymer.

6. The linerboard of claim 1 wherein the binder comprises starch and a styrene butadiene copolymer.

7. The linerboard of claim 1 wherein the binder is present in the coating composition at a concentration from about 20 percent to about 40 percent by weight.

8. The linerboard of claim 1 wherein the coating composition further comprises an additive selected from the group consisting of defoamers, biocides, viscosity modifiers, rheology modifiers, cross-linkers, optical brighteners, and combinations thereof.

9. The linerboard of claim 1 wherein the calcined clay is present in the coating composition at a concentration from about 60 percent to about 70 percent by weight.

10. The linerboard of claim 1 wherein the coating composition has a weight on the board from about 0.5 pounds per one thousand square feet to about 10 pounds per one thousand square feet.

11. The linerboard of claim 1 wherein the coating composition has a weight on the board from about 3 pounds per one thousand square feet to about 5 pounds per one thousand square feet.

12. The linerboard of claim 1 wherein the board is selected from the group consisting of bleached linerboards, white-top linerboards, unbleached linerboards and combinations thereof.

13. A method of printing comprising:
applying an ink layer to at least one surface of a substrate having a porous coating composition, the porous coating composition comprising from about 55 to about 85 percent by weight calcined clay and a binder.

14. The method of claim 13 wherein the ink is applied via a flexographic printing process.

15. The method of claim 13 wherein the substrate comprises a linerboard.

16. The method of claim 13 wherein the binder is present in the coating composition at a concentration from about 20 percent to about 40 percent by weight.

17. The method of claim 13 wherein the binder comprise starch and a styrene butadiene copolymer.

18. The method of claim 13 wherein the coating composition has a weight on the substrate from about 0.5 pounds per one thousand square feet to about 10 pounds per one thousand square feet.

19. The method of claim 13 wherein the coating composition comprises form about 20 percent to about 40 percent by weight titanium dioxide.

20. The method of claim 13 further comprising applying a second layer of ink to the at least one surface of a substrate having the porous coating composition.

21. A coating composition comprising:
from about 55 percent to about 85 percent calcined clay, from about 20 to about 40 percent binder, and from about 5 percent to about 15 percent titanium dioxide.

22. A method of forming a corrugated board comprising:
operably coupling a corrugated substrate with a linerboard, the linerboard comprising a porous coating composition being able to absorb water and comprising from about 55 to about 85 percent by weight calcined clay and a binder.
